(19) United States
(12) Patent Application Publication
(10) Pub. No.: US 2026/0073427 A1
(43) Pub. Date: Mar. 12, 2026

(54) SCHEDULING ACCESS POINT AND ELECTRONIC SHELF LABEL COMMUNICATION

(71) Applicant: QUALCOMM Incorporated, San Diego, CA (US)

(72) Inventors: Xin WU, Shanghai (CN); Jie ZHANG, Shanghai (CN); Nicolas GRAUBE, Cambridge (GB); Feng CHEN, Shanghai (CN); Junqi MIAO, Shanghai (CN); Daqing LI, Suzhou (CN); Linghui WU, Shanghai (CN)

(21) Appl. No.: 19/104,962

(22) PCT Filed: Sep. 29, 2022
(86) PCT No.: PCT/CN2022/122488

§ 371 Date: Feb. 19, 2025

(51) Int. Cl. G06Q 30/0251

(52) U.S. Cl. CPC G06Q 30/0267; G06Q 30/0264

(57) ABSTRACT

Various embodiments include methods performed by an access point (AP) and an electronic shelf label (ESL) for scheduling access point and electronic shelf label communication. In some embodiments, an AP may broadcast to one or more ESLs a periodic advertisement including scheduling information for an advertisement message (ADV) from the one or more ESLs, and receive the ADV from one or more of the ESLs according to the scheduling information. In some embodiments, an ESL may receive from an AP a periodic advertisement including scheduling information for an ADV from the ESL and transmit the ADV to the AP according to the scheduling information.

### BACKGROUND

Electronic Shelf Labels (ESLs) have been introduced in supermarkets, supply stores, warehouses, and the like to improve inventory tracking, product mapping, price change rollouts, and the customer experience generally. The ESLs and a management entity server or other computing device may communicate wirelessly via an Access Point (AP) to manage the ESLs, as well as the data associated with the ESLs. Meanwhile, such facilities often provide a Wireless Local Area Network (WLAN) capability, such as Wi-Fi, for associates, customers, and/or other support systems. However, ESL and WLAN communications may compete for wireless resources when the AP is configured to support both communication protocols.

### SUMMARY

Various aspects of the present disclosure include methods, systems, and devices for scheduling communications of an electronic shelf label (ESL) network and an access point (AP). Various aspects performed by a processor of an AP may include broadcasting to one or more ESLs a periodic advertisement including scheduling information for an advertisement message (ADV) from the one or more ESLs, and receiving the ADV from one or more of the ESLs according to the scheduling information.

In some aspects, broadcasting to one or more ESLs the periodic advertisement including scheduling information for an ADV from the one or more ESLs may include broadcasting to one or more ESLs the periodic advertisement including an indication of one or more occupied sub-slots, and receiving the ADV from one or more of the ESLs according to the scheduling information may include receiving the ADV from one or more of the ESLs in an unoccupied sub-slot. In some aspects, broadcasting to one or more ESLs the periodic advertisement including scheduling information for an ADV from the one or more ESLs may include configuring the one or more ESLs into ESL groups associated with times at which another radio frequency (RF) transmitter is not expected to transmit, and broadcasting the periodic advertisement to the ESL groups at the times at which the other RF transmitter is not expected to transmit. In some aspects, configuring the one or more ESLs into ESL groups associated with times at which another RF transmitter is not expected to transmit may include configuring the ESL groups according to a static ratio of times at which the other RF transmitter is not expected to transmit and times at which the other RF transmitter is expected to transmit.

In some aspects, broadcasting to one or more ESLs the periodic advertisement including scheduling information for the ADV from the one or more ESLs may include transmitting to an ESL associated with an ESL ID an indication of a sub-slot. In such aspects, receiving the ADV from one or more of the ESLs according to the scheduling information may include receiving from the ESL associated with the ESL ID the ADV in the indicated sub-slot.

In some aspects, transmitting to the ESL using the associated ESL ID the indication of the sub-slot may include transmitting to the ESL associated with the ESL ID an indication of a position in the sub-slot, and receiving from the ESL associated with the ESL ID the ADV in the indicated sub-slot may include receiving from the ESL associated with the ESL ID the ADV in the indicated position in the indicated sub-slot.

In some aspects, transmitting to the ESL associated with the ESL ID the indication of the sub-slot may include transmitting to the ESL associated with the ESL ID an advertising interval, a quantity of ADVs to transmit, and an indication of a channel in which to transmit the ADV, and receiving from the ESL associated with the ESL ID the ADV in the indicated sub-slot may include receiving from the ESL associated with the ESL ID the ADV according to the advertising interval, the quantity of ADVs to transmit, and the indication of the channel in which to transmit the ADV. In some aspects, receiving the ADV from one or more of the ESLs according to the scheduling information may include determining an AP scan window based on the scheduling information, and receiving the ADV from one or more of the ESLs during the determined AP scan window.

Further aspects include an AP configured with a processor for performing one or more operations of any of the methods summarized above. Further aspects include a non-transitory processor-readable storage medium having stored thereon processor-executable instructions configured to cause a processor of an AP to perform operations of any of the methods summarized above. Further aspects include an AP having means for performing functions of any of the methods summarized above.

Various aspects performed by a processor of an ESL may include receiving from an access point (AP) a periodic advertisement including scheduling information for an advertisement message (ADV) from the ESL, and transmitting the ADV from the ESL to the AP according to the scheduling information.

In some aspects, receiving from the AP the periodic advertisement including scheduling information for an ADV from the ESL may include receiving from the AP the periodic advertisement including an indication of one or more occupied sub-slots, and transmitting the ADV to the AP according to the scheduling information may include transmitting the ADV to the AP according to the scheduling information in an unoccupied sub-slot. In some aspects, receiving from the AP the periodic advertisement including scheduling information for an ADV from the ESL may include receiving information that configures the ESL into an ESL group associated with times at which another radio frequency (RF) transmitter is not expected to transmit, and receiving the periodic advertisement that is broadcast to the ESL group at the time at which the other RF transmitter is not expected to transmit. In some aspects, receiving information that configures the ESL into the ESL group associated with times at which another RF transmitter is not expected to transmit may include receiving information that configures the ESL the ESL group according to a static ratio of times at which the other RF transmitter is not expected to transmit and times at which the other RF transmitter is expected to transmit.

In some aspects, receiving from the AP the periodic advertisement including scheduling information for an ADV from the ESL may include receiving from the AP the periodic advertisement addressed to an ESL ID of the ESL including an indication of a sub-slot, and transmitting the ADV to the AP according to the scheduling information may include transmitting the ADV to the AP in the indicated sub-slot. In some aspects, receiving from the AP the periodic advertisement addressed to the ESL ID of the ESL including the indication of the sub-slot may include receiving from the AP an indication of a position in the sub-slot, and transmitting the ADV to the AP in the indicated sub-slot may include transmitting the ADV to the AP in the indicated position in the indicated sub-slot. In some aspects, receiving from the AP the periodic advertisement addressed to the ESL ID of the ESL including the indication of the sub-slot may include receiving from the AP an advertising interval, a quantity of ADVs to transmit, and an indication of a channel in which to transmit the ADV, and transmitting the ADV to the AP in the indicated sub-slot may include transmitting the ADV to the AP according to the advertising interval, the quantity of ADVs to transmit, and the indication of the channel in which to transmit the ADV.

Further aspects include an ESL configured with a processor for performing one or more operations of any of the methods summarized above. Further aspects include a non-transitory processor-readable storage medium having stored thereon processor-executable instructions configured to cause a processor of an ESL to perform operations of any of the methods summarized above. Further aspects include an ESL having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram illustrating an ESL network and a WLAN network supported by a single AP suitable for implementing any of the various embodiments.

FIG. 2 is a component block diagram illustrating an example computing and wireless modem system on a chip suitable for use in a computing device implementing any of the various embodiments.

FIG. 3 is a conceptual diagram illustrating a method of scheduling access point and electronic shelf label communication according to various embodiments.

FIG. 4A is a conceptual diagram illustrating a method of scheduling access point and electronic shelf label communication according to various embodiments.

FIG. 4B illustrates an example bitmap that may be used as part of the method of scheduling access point and electronic shelf label communication according to various embodiments.

FIG. 5A is a conceptual diagram illustrating a method of scheduling access point and electronic shelf label communication according to various embodiments.

FIG. 5B is a block diagram illustrating example scheduling information according to various embodiments.

FIG. 5C is a conceptual diagram illustrating a method of scheduling access point and electronic shelf label communication according to various embodiments.

FIG. 6A is a process flow diagram illustrating a method for scheduling access point (AP) and electronic shelf label (ESL) communication according to various embodiments.

FIGS. 6B-6E are process flow diagrams illustrating operations that may be performed as part of the method for scheduling access point (AP) and electronic shelf label (ESL) communication according to various embodiments.

FIG. 7A is a process flow diagram illustrating a method for scheduling access point (AP) and electronic shelf label (ESL) communication according to various embodiments.

FIGS. 7B-7D are process flow diagrams illustrating operations that may be performed as part of the method for scheduling access point (AP) and electronic shelf label (ESL) communication according to various embodiments.

FIG. 8 is a component block diagram of an ESL suitable for use with various embodiments

FIG. 9 is a component block diagram of an access point suitable for use with various embodiments.

FIG. 10 is a component block diagram of a store management entity server suitable for use with various embodiments.

FIG. 11 is a component block diagram of a user mobile device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, various embodiments include methods, and systems implementing the methods, for scheduling communications between ESLs and an AP. In various embodiments, the AP may provide information to ESLs that enable the ESLs to transmit messages to the AP at a time and/or in a manner that avoids, for example, conflict with another message or signal transmitted by or to the AP. In some embodiments, the AP may provide ESLs with information about potentially conflicting messages or signals. In some embodiments, the AP may provide ESLs with scheduling information about when the ESLs should transmit messages to the AP. In some embodiments, ESLs may receive from the AP a message that includes scheduling information, and may transmit a message to the AP according to the scheduling information.

The term “electronic shelf label” or “ESL” is used herein to refer to a computing device with an electronic display that can be placed or secured to, in, on, or near store shelves. The ESL may include a processor, memory, a display, and one or more wireless transceivers, in which the processor may be programmed or provided data to render images (e.g., text, bar codes, trademarks, etc.) that communicate information (e.g., to people) regarding products near the device. In some aspects, ESLs may be battery powered to enable placement on or near products without the need for a power infrastructure. Alternatively, an ESL may be supplied power by the shelve to which the ESL is secured.

ESLs may be programmed, reprogrammed or updated via messages transmitted by the AP at any time with product information rendered on the display. Thus, ESLs that serve the function of paper shelf labels with the added efficiency of enabling product information (e.g., prices) can be changed without physically replacing shelf labels. While various embodiments are described with reference to ESLs being placed on shelves within a store, ESLs may also be positioned on large goods (e.g., furniture, appliances, etc.), on or near stands or stacks of goods, on pallets on which products are positioned, and other locations where products may be offered for sale or selection. Further, ESLs may be used for other purposes, such as placed on doors to indicate vacant or occupied status. Thus, the “S” in ESL is not intended to limit the claims to labels that are only positioned on shelves.

As used herein, the term “user” refers to a network operator or an external smart agent/module/application that has the capability of detecting and/or triggering user scenario changes.

As used herein, the term “computing device” refers to an electronic device equipped with at least a processor, memory, and a device for presenting output such as a location of an object or objects of interest. In some embodiments, a computing device may include wireless communication devices such as a transceiver and antenna configured to communicate with wireless communication networks. A computing device may include any one or all of an outer smart device, a base-band, smart watches, smart rings, smart necklaces, smart glasses, smart contact lenses, contactless sleep tracking devices, smart furniture such as a smart bed or smart sofa, smart exercise equipment, Internet of Things (IoT) devices, augmented/virtual reality devices, cellular telephones, smartphones, portable computing devices, personal or mobile multimedia players, laptop computers, tablet computers, 2-in-1 laptop/table computers, smart books, ultrabooks, multimedia Internet-enabled cellular telephones, entertainment devices (e.g., wireless gaming controllers, music and video players, satellite radios, etc.), and similar electronic devices that include a memory, wireless communication components and a programmable processor. In some embodiments, a computing device may be wearable device by a person. As used herein, the term “smart” in conjunction with a device, refers to a device that includes a processor for automatic operation, for collecting and/or processing of data, and/or may be programmed to perform all or a portion of the operations described with regard to various embodiments.

The term “mobile wireless device” is used herein to refer to computing devices that include any one or all of customer smartphones, a store picker's mobile wireless device, cellular telephones, portable computing devices, laptop computers, tablet computers, smartbooks, ultrabooks, palmtop computers, multimedia Internet-enabled cellular telephones, wearable devices including smart watches, smart clothing, smart glasses, earbuds, headphones, smart wrist bands, and similar electronic devices that include a memory, wireless communication components and a programmable processor.

The term “user mobile device” is used to refer to a mobile wireless device that is specifically configured to support users within a store, such as the store picker job functioning within a store picker system according to various embodiments. A store picker wireless device may include a processor, memory, an electronic display, wireless transceiver(s) including a Bluetooth transceiver and Wi-Fi transceiver, a barcode scanner, and other components useful for store picking.

The term “store” when used herein with reference to a physical place refers to a wholesale, retail, or other building in which products are stored for sale and/or distribution. A store may include (but is not limited to) a warehouse, fulfillment center, department store, specialty store, market, supermarket, hypermarket, convenience store, discount store, super store, and/or other storage facility.

The term “product” is used herein to refer to one or more items, articles, merchandise, or substances that are collected, refined, manufactured, and/or assembled and are maintained in a store or the like, such as products that may be identified on a shopping list and picked by store pickers.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high-speed communication circuitry and packaged in close proximity, such as on a single motherboard or in a single computing device. The proximity of the SOCs facilitates high speed communications and the sharing of memory and resources.

An AP may use Bluetooth ESLs profiles to manage thousands of ESLs. According to such profile(s), the AP may scan for a signal from one or more ESLs in time slots in which no conflicting communication activity is scheduled, such as the broadcast of a periodic advertisement, an ESL response (e.g., an ESL response message (ERP)), or communication link connection or maintenance activities. A time period during which an AP scans for a signal from one or more ESLs is referred to herein as an “AP scan window.” A time period during which an ESL scans for a signal from the AP is referred to herein as an “ESL scan window.” An ESL may transmit or broadcast an advertising message (“ADV”) to initiate a process of establishing or reestablishing a communication link with the AP. The AP may receive the ADV during one or more AP scan windows. In some embodiments, the AP may initiate the process of establishing or reestablishing a communication link with the ESL based on the received ADV.

The scheduling configuration of current ESL systems causes severe message conflict between messages or signals sent by various ESLs. An ESL system may include up to hundreds or even thousands of ESLs. Each ESL may transmit an ADV in one of three broadcast channels, in an unsynchronized manner, which may cause packet reception conflict for the AP, and dramatically increase the time required for the AP to receive information from and prepare for communication with (i.e., “discover”) each ESL.

Additionally, the scheduling configuration of current ESL systems causes high power consumption of ESL battery power. Currently, each ESL may transmit information (e.g., an ADV) for the AP at a randomly selected time, at which or during which the AP may or may not receive the ESL's information. For example, conventional ESLs may be configured to transmit an ADV for up to 20 seconds, and then timeout if the AP has not initiated a connection with the ESL. Since the AP is typically configured to scan for ESL signals only within AP scan windows, ESLs waste power and unnecessarily consume network communication resources when broadcasting signals at times when the AP cannot receive the signal (e.g., outside the AP's scan window). Packet conflicts and the failure to receive signals is exacerbated by signal coexistence with other radio access technologies, such as Wi-Fi, which may use the same signal frequencies as the ESL system.

Various embodiments include methods, and APs and ESLs configured to implement the methods, for scheduling communications between ESLs and an AP in more efficient manners. Various embodiments improve the efficiency and resource consumption of ESL systems, APs, and ESLs by enabling APs and ESLs to schedule communications, such as advertising messages (ADVs). In various embodiments, an AP may broadcast to one or more ESLs a periodic advertisement including scheduling information for an ADV from the one or more ESLs. The AP may receive the ADV from one or more of the ESLs according to the scheduling information.

In some embodiments, the AP may broadcast to one or more ESLs the periodic advertisement including an indication of one or more occupied sub-slots. The AP may receive the ADV from one or more of the ESLs according to the scheduling information including receiving the ADV from one or more of the ESLs in an unoccupied sub-slot. In some embodiments, the periodic advertisement broadcast by the AP to the one or more ESLs may include a bitmap that indicates occupied sub-slots. As one example, the periodic advertisement broadcast by the AP to the one or more ESLs may include a three-bit indication of the occupied sub-slots.

In some embodiments, the AP may configure the one or more ESLs into ESL groups associated with times at which another radio frequency (RF) transmitter is not expected to transmit. The AP may broadcast the periodic advertisement to the ESL groups at the times at which the other RF transmitter is not expected to transmit. In some embodiments, the AP may receive the ADV from one or more of the ESLs in an AP scan window at the times at which the other RF transmitter is not broadcasting. In some embodiments, the AP may configure the ESL groups according to a static ratio of times at which the other RF transmitter is not expected to transmit and times at which the other RF transmitter is expected to transmit.

In some embodiments, the AP may transmit to an ESL associated with an ESL ID an indication of a sub-slot in which to received messages. In particular, the AP may receive the ADV from one or more of the ESLs according to the scheduling information including receiving from the ESL associated with the ESL ID the ADV in the indicated sub-slot. In some embodiments, the periodic advertisement broadcast by the AP may include an indication of the static ratio. In some embodiments, the AP may transmit to the ESL associated with the ESL ID an indication of a position in the sub-slot. The AP may receive the ADV from the ESL associated with the ESL ID in the indicated position in the indicated sub-slot. In some embodiments, the AP may transmit to the ESL associated with the ESL ID an advertising interval, a quantity of ADVs to transmit, and an indication of a channel in which to transmit the ADV. The AP may receive from the ESL associated with the ESL ID the ADV according to the advertising interval, the quantity of ADVs to transmit, and the indication of the channel in which to transmit the ADV.

In various embodiments, an ESL may receive from an AP a periodic advertisement that includes scheduling information for an ADV from the ESL, and the ESL may transmit the ADV to the AP according to the scheduling information. In some embodiments, the ESL may receive from the AP the periodic advertisement including an indication of one or more occupied sub-slots. The ESL may transmit the ADV to the AP according to the scheduling information in an unoccupied sub-slot. In some embodiments, the ESL may receive information that configures the ESL into an ESL group associated with times at which another radio frequency (RF) transmitter is not expected to transmit, and may receive the periodic advertisement that is broadcast to the ESL group at the time at which the other RF transmitter is not expected to transmit. In some embodiments, the ESL may transmit the ADV to the AP in an AP scan window at the time at which the other RF transmitter is not broadcasting. In some embodiments, the ESL may receive information that configures the ESL or the ESL group according to a static ratio of times at which the other RF transmitter is not expected to transmit and times at which the other RF transmitter is expected to transmit. In some embodiments, the periodic advertisement received by the ESL may include an indication of the static ratio.

In some embodiments, the ESL may receive from the AP the periodic advertisement addressed to an ESL ID of the ESL and comprising an indication of a sub-slot. The ESL may transmit the ADV to the AP in the indicated sub-slot. In some embodiments, the ESL may receive from the AP an indication of a position in the sub-slot. The ESL may transmit transmitting the ADV to the AP in the indicated position in the indicated sub-slot. In some embodiments, the ESL may receive from the AP an advertising interval, a quantity of ADVs to transmit, and an indication of a channel in which to transmit the ADV. The ESL may transmit the ADV to the AP according to the advertising interval, the quantity of ADVs to transmit, and the indication of the channel in which to transmit the ADV.

Various embodiments improve the reception (or likelihood of reception) of ADVs from ESLs by APs by scheduling the transmission of ADVs by ESLs during one or more AP scan windows. Various embodiments improve the operation of ESLs by reducing unnecessary ESLs power consumption caused by transmitting ADVs at a time when APs may not or cannot receive the ADVs. Various embodiments improve the operation of ESLs by reducing message reception failures caused by transmitting ADVs at a time when APs may not or cannot receive the ADVs, which may lead to unnecessary message retransmissions. Various embodiments improve the operation of APs by increasing the reception of ADVs from ESLs by the AP.

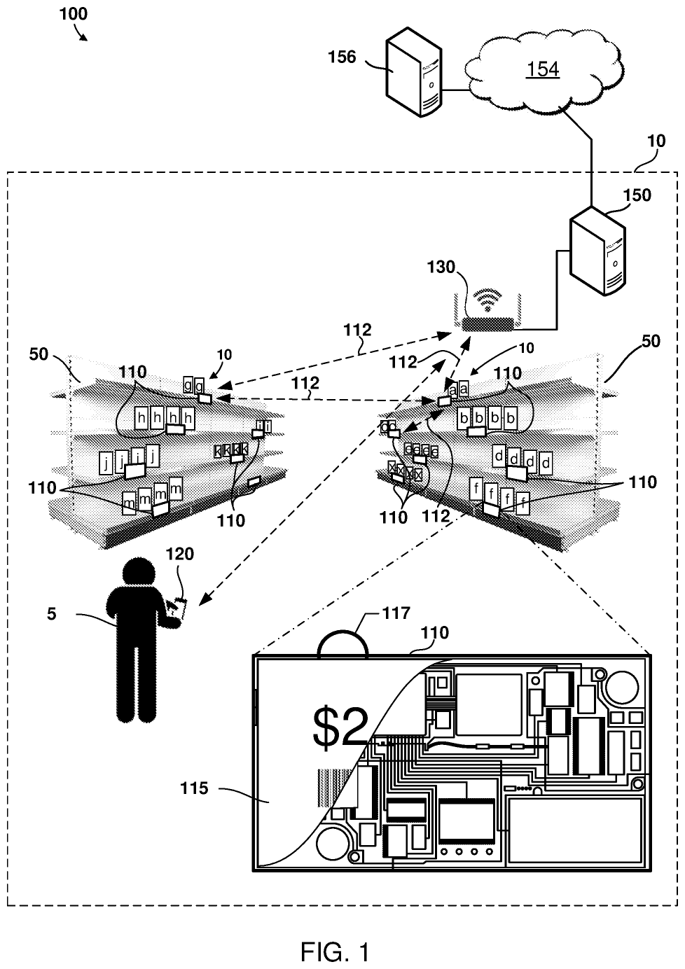

FIG. 1 is a component block diagram of a shared ESL and WLAN communication system 100 supported by a shared ESL/WLAN AP suitable for implementing various embodiments. The shared ESL and WLAN system 100 may be deployed within a given store 10 that includes one or more ESL/WLAN APs 130 supporting the WLAN (e.g., Wi-Fi network) and communicating with a plurality of ESLs 110 deployed on shelves 50 via Bluetooth communication protocols. The APs 130 may be configured to both communicate information to ESLs 110 and to relay information from ESLs 110 to a store management entity server 150, as well as receive control commands from the store management entity server 150.

ESLs 110 may be positioned on shelves 50 associated with products (labeled a, b, c, d, e, f, g, h, i, j, k, and m). Each ESL 110 may include a display 115 on which is presented product name, product codes, prices, stocking information, barcodes, and the like. In some embodiments, not every ESL will be configured and/or equipped the same or with the same capabilities. The ESLs 110 may be configured to receive communications from the store management entity server 150, such as through wireless links 112 that may be relayed via the APs 130.

The store management entity server 150 may configure each ESL 110 with product information to be displayed, as well as duty cycles for when the ESL should activate to receive signals and transmit wireless beacons. The store management entity server 150 may control the periodicity of ESL duty cycles in order to minimize battery drain/usage, so as to extend the operating life, while ensuring the ESL is responsive to customers and store pickers, such as by increasing the duty cycle when individuals are within proximity of an ESL (e.g., close enough to see and/or read a display of the ESL).

Further, the store management entity server 150 may configure ESLs 110 to generate an appropriate indication (e.g., visual, audible, and/or tactile indications) at an appropriate time, such as when an ESL is associated with a product that appears on a shopping list of a user that is nearby (e.g., within a predetermined distance). In various implementations, the store management entity server 150 may be located within or near the store, or located remotely, such as in the Cloud, and accessed via a network, such as the Internet.

ESLs 110 may be configured to exchange wireless communications with each other through wireless links 112, such as wireless beacons or tones, for various purposes, including in particular for determining the relative and actual location of the ESLs on shelves 50 and with respect to one another as described herein.

In many implementations of ESL networks, such as stores, warehouses, and the like, a WLAN capability, such as a Wi-Fi network, may also be deployed such as to support communications with user mobile devices 120 (e.g., (e.g., smartphones, tablet computers, laptops, etc.). In some implementations, the WLAN will be supported by one or more APs that also sends wireless signals (e.g., Wi-Fi signals that carry Wi-Fi packets) to and receive wireless signals from various wireless devices and provide access to internal and external networks 154, such as the Internet. For example, in addition to being personal mobile devices of users 5, mobile devices 120 that may be used in the shared ESL/WLAN system 100 may include smart watches, body cams, augmented reality glasses (e.g., smart glasses), and facility-specific or enterprise-specific handheld devices that are configured specifically for store pickers or other customers/users.

ESLs 110 may be configured to communicate with APs 130 via wireless links 112, such as Bluetooth or Bluetooth Low Energy (BLE) protocol communications. For example, ESLs 110 may transmit certain BLE signals 112, such as ESL advertisements, that are configured to be received by a nearby AP 130 and used to onboard the ESL 110. BLE signals 112 may be broadcast at a set or select power level, enabling separation distances to be estimated based upon the measured received signal strength indicator (RSSI) of the signals received by other ESLs 110. APs 130 may be coupled to the store management entity server 150 via wired connections.

The WLAN access points 130 may provide user mobile devices 120 with access to external networks 154, such as the Internet to enable customers to access remote servers 156, such as to comparison shop, research products, and otherwise provide Internet access support.

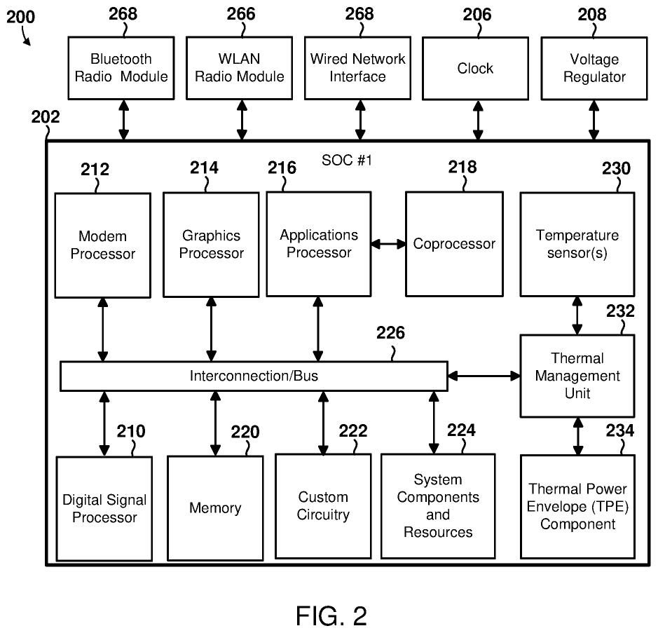

FIG. 2 is a component block diagram illustrating a non-limiting example of a computing and wireless modem system 200 in a computing device suitable for implementing any of the various embodiments. Various embodiments may be implemented on a number of single processor and multiprocessor computer systems, including a system-on-chip (SOC) or system in a package (SIP).

With reference to FIGS. 1-2, the illustrated example computing system 200 (which may be a SIP in some embodiments) includes an SOC 202 coupled to a clock 206, a voltage regulator 208, a WLAN radio module 266 configured to send and receive wireless communications, such as Wi-Fi packets, via an antenna (not shown), a Bluetooth radio module 268 configured to send and receive wireless communications, including BLE messages, via an antenna (not shown), and wired network interface 268 configured to communicate with wired networks (e.g., ethernets). When the computing system 200 is used in ESL/WLAN APs, the Bluetooth radio module 268 may be configured to broadcast BLE beacons as described herein. In some implementations, the SOC 202 may operate as central processing unit (CPU) of the user mobile device that carries out the instructions of software application programs by performing the arithmetic, logical, control and input/output (I/O) operations specified by the instructions.

The SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234 . . .

Each processor 210, 212, 214, 216, 218 may include one or more cores, and each processor/core may perform operations independent of the other processors/cores. For example, the SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218 may be included as part of a processor cluster architecture (such as a synchronous processor cluster architecture, an asynchronous or heterogeneous processor cluster architecture, etc.).

The SOC 202 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the SOC 202 may include power amplifiers, voltage regulators, oscillators, phase-locked loops, peripheral bridges, data controllers, memory controllers, system controllers, access ports, timers, and other similar components used to support the processors and software clients running on a user mobile device. The system components and resources 224 or custom circuitry 222 also may include circuitry to interface with peripheral devices, such as cameras, electronic displays, wireless communication devices, external memory chips, etc.

The various processors 210, 212, 214, 216, 218 may be interconnected to one or more memory elements 220, system components and resources 224, and custom circuitry 222, and a thermal management unit 232 via an interconnection/bus module 226. The interconnection/bus module 226 may include an array of reconfigurable logic gates or implement a bus architecture (such as CoreConnect, AMBA, etc.). Communications may be provided by advanced interconnects, such as high-performance networks-on chip (NoCs).

The SOC 202 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

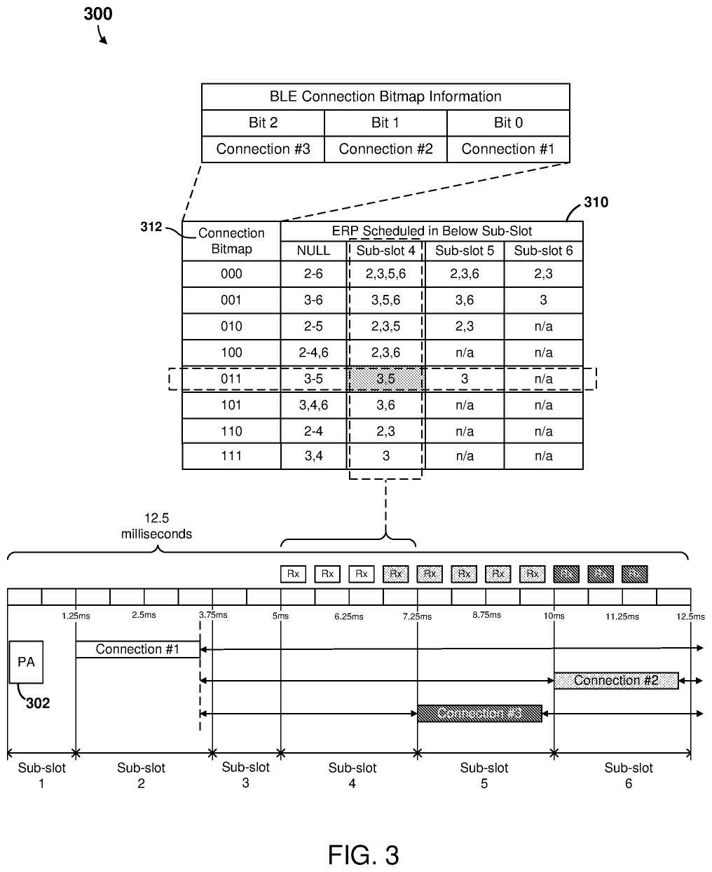

FIG. 3 is a conceptual diagram illustrating a method 300 of scheduling access point and electronic shelf label communication according to various embodiments. With reference to FIGS. 1-3, in some embodiments, a connection interval (i.e., an interval during which BT communications occur) may be configured every 12.5 milliseconds. In some embodiments, the connection interval may include six sub-slots (e.g., sub-slots 1-6).

In some embodiments, an AP (e.g., 130) may configure a periodic advertisement (PA) 302 to include information 310 indicating whether connections (or other communications) are scheduled in a particular sub-slot. The AP may include such information 310 in the periodic advertisement 302 because the AP is aware of a number of ongoing connections (e.g., BLE connections) currently established (handled, maintained) by the AP. The AP may broadcast the PA 302 to one or more ESLs (e.g., 110) to provide the ESLs with an indication of one or more occupied sub-slots.

In some embodiments, the AP may configure the PA 302 with a three-bit indication of the occupied sub-slots (connection bitmap 312). For example, a first bit (bit 0) may indicate a first connection (connection #1), a second bit (bit 1) may indicate a second connection (connection #2), and a third bit (bit 2) may indicate a third connection (connection #3). In some embodiments, the value of each bit may indicate whether a connection is scheduled (“1”) or not scheduled (“0”) during a connection interval (e.g., the illustrated 12.5 millisecond connection interval). Using the indication of the one or more occupied sub-slots in the PA, ESLs may calculate the AP's scan window (an AP scan window) which sub-slots are vacant, based on the right table by given both ERP information and 3-bit connection information from PA.

The table in FIG. 3 is constructed based on current ESL AP's schedule logic. Based on the sub-slot division information shown in FIG. 3, 11 ERP slots (1-11) are divided into 3 parts, namely sub-slots 4, 5, and 6. Subslots 1-4 are for ERP information. Subslots 5 and 6 are shared with BLE connection #3 and #2. The value in subslot 4 indicates that this subslot is only for ERP information and there is no BLE connection use such time period.

In the table shown in FIG. 3, the inputs include the BLE connection usage information, namely ‘1’ means the related BLE connection is used/on-going; ‘0’ means the related BLE connection is not used. This information can be found in AP's PA which is newly added in various embodiments. The other table input information of the ERP slot usage information can be found in the AP's PA. The table then provides as outputs the vacant subslots by providing above two inputs.

In the illustrated example, the BLE connection Information bitmap ‘011’ means that BLE connections #1 and #2 are used while connection #3 is not used. Information in each cell of the connection bitmap 312 may indicate one or more available sub-slots, which may be expressed as a range (e.g., “3-5” sub-slots), or as discrete sub-slots (e.g., “3,5” meaning sub-slots 3 and 5). For example, connection bitmap value 011, in sub-slot 4, indicates that sub-slots 3 and 5 are unoccupied (“3,5”). The connection bitmap 312 also indicates connection #1 (sub-slot 2) and connection #2 (sub-slot 6), and ERP 0, 1,2 or 3. The illustrated example also shows ERP slot information indicating that sub-slot 4 is used and scheduled by the AP. This also indicates by omission that subslots 5 and 6 are not used for communicating ERP information. In some embodiments, the connection bitmap 312 also may be constructed with an assumption that that ERP slots are used starting from ERP slot #1, so if ERP slot ‘N’ is not used (i.e., there is no value), subsequent ERP slots should not be used.

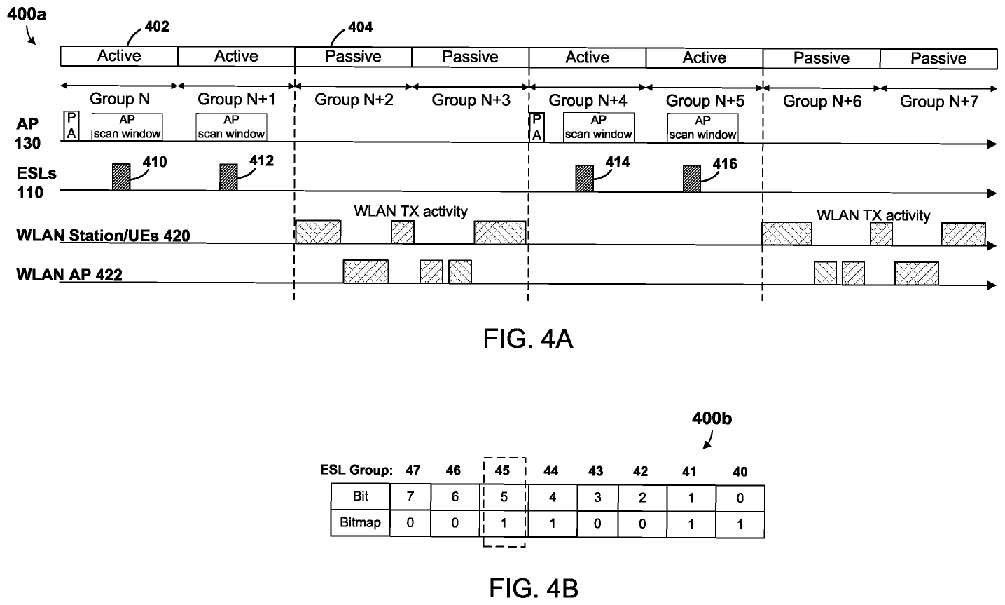

FIG. 4A is a conceptual diagram illustrating a method 400a of scheduling access point and electronic shelf label communication according to various embodiments. FIG. 4B illustrates an example bitmap 400b that may be used as part of the method 400a according to various embodiments. With reference to FIGS. 1-4B, in some embodiments, the ESL system may operate in proximity with another radio frequency (RF) system using signals that may conflict with signals of the ESL system, such as a Wi-Fi system or another similar system (illustrated as WLAN Stations 420 and WLAN AP 422). In some embodiments, an AP (e.g., 130) may configure groups of ESLs (e.g., 110) to avoid signal coexistence with other signals.

For example, communication opportunities (e.g., using Bluetooth Asynchronous Connection-Less (ACL) transport) may be configured in time units defined by protocol, such as time slots. It some embodiments, a time slot may be equal to a transmit/receive turn-around time, channel sensing time, propagation delay, and/or processing time. For example, the time slots may define intervals for the transmission (Tx) and/or reception (Rx) of data (e.g., 12.5 millisecond intervals). An AP may establish and repeat a pattern of Tx and Rx. It some embodiments, an AP may assign an ESL to listen (monitor for a signal, attempt to receive) for a Tx along with a select group of other ESLs, so that different groups may listen during different time slots (i.e., each group may be assigned a time slot). For example, if an ESL profile specification provides for 128 groups, each ESL may listen at least every 1.6 seconds.

In some embodiments, the AP may assign or categorize ESL groups into different types. In some embodiments, the AP may configure one or more ESLs into ESL groups associated with times at which another RF transmitter is not expected to transmit. The AP may broadcast the periodic advertisement (PA) to the ESL groups at the times at which the other RF transmitter is not expected to transmit. An ESL may receive the information that configures the ESL into an ESL group associated with times at which the other RF transmitter is not expected to transmit. The ESL may receive the periodic advertisement that is broadcast to the ESL group at the time at which the other RF transmitter is not expected to transmit. In some embodiments, the ESL may transmit an ADV (e.g., 410, 412, 414, 416) at the time at which the other RF transmitter is not expected to transmit.

For example, an AP may identify or assign ESLs into an “active” group 402 that includes at least one ESL, and a “passive” group 404 that does not include any ESLs. In some embodiments, the AP may assign times associated with passive groups 404 to other systems, such as the WLAN Stations 420 and/or WLAN AP 422. In some embodiments, the AP may assign or organize passive groups 404 for or during times corresponding to transmission occasions of the other RF system.

In some embodiments, the AP may allocate time to each passive group 404 and active group 402 according to a ratio, such as 2:2, 1:3, 1:7. In some embodiments, such a ratio may be configured according to a scale of an ESL network or system and/or different key performance indicator (KPI) requirements of the ESL system. In some embodiments, the AP may allocate passive and active groups statically, for example, during a connection interval.

For example, groups N+2, N+3, N+4, and N+5, may be associated with passive groups, during which time WLAN stations (UEs) and/or APs may transmit WLAN signals without coexisting with ESL system signals from the AP or an ESL. The AP may configure a periodic advertisement (or one or more periodic advertisements) with information indicating the configuration of active and passive groups. In some embodiments, the AP may configure the periodic advertisement(s) with bitmap information (e.g., the bitmap 400b) indicating the allocation or configuration of active and passive groups. In some embodiments, the AP may allocate or configure active and passive groups into a regular, repeatable organization that reduces a number of bytes in the periodic advertisement needed to address all possible ESL groups (e.g., all 128 groups).

Referring to the example bitmap 400b, in some embodiments, the AP may use one byte (e.g., of 8 bits) to encode the bitmap information indicating the configuration of active and passive groups. In some embodiments, a byte range of 0000 0001-1111 1110 may provide a sufficient range of byte options to convey all needed Active: Passive ratios. For example, a byte 0000 0001 may indicate that Group 0 is allocated for ESLs, and Groups 1-7 are allocated for WLAN communications. As another example, a byte 0011 0011 may indicate that Groups 0-1 and 4-5 are allocated for ESLs, and Groups 2-3 and 6-7 are allocated for WLAN communications. As yet another example, a byte 0001 0001 may indicate that Groups 0 and 4 are allocated for ESL, and that Groups 1-3 and 5-7 are allocated for WLAN communications.

Each ESL may perform operations using an 8-bit bitmap to generate an entire Active: Passive group bitmap of 128 bits. In some embodiments, an ESL may repeat an 8-bit bitmap 16 times (128/8=16) to determine an entire Active: Passive group bitmap of 128 bits. In some embodiments, an ESL that receives a periodic advertisement of a Group N may divide N by 8 to obtain a bit position in the bitmap. For example, in the bitmap 400b has a value of 0011 0011. The relevant information for group 45 is located at in bit 45/8=5. A bit value of “1” indicates that Group 45 is an active group. The ESL also may use information in the bitmap 400b to identify whether other groups are active groups or passive groups. In some embodiments, an ESL may combine operations of the method 400b with operations of the method 300 (FIG. 3) to identify one or more AP scan windows (e.g., at the sub-slot level). Each ESL may transmit an ADV in such identified AP scan window(s), which may increase the probability that the AP may successfully receive the ADV from the ESL.

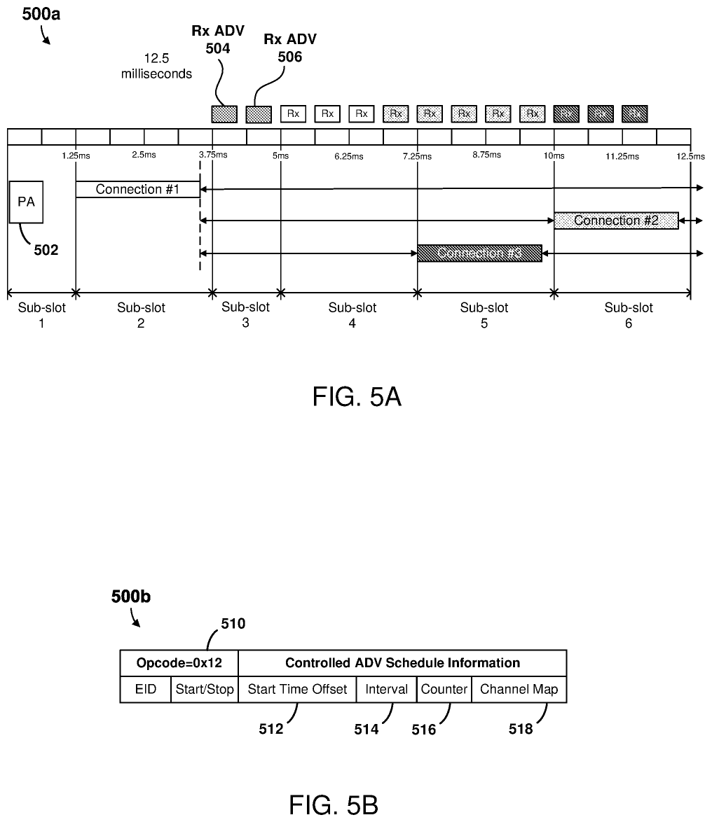

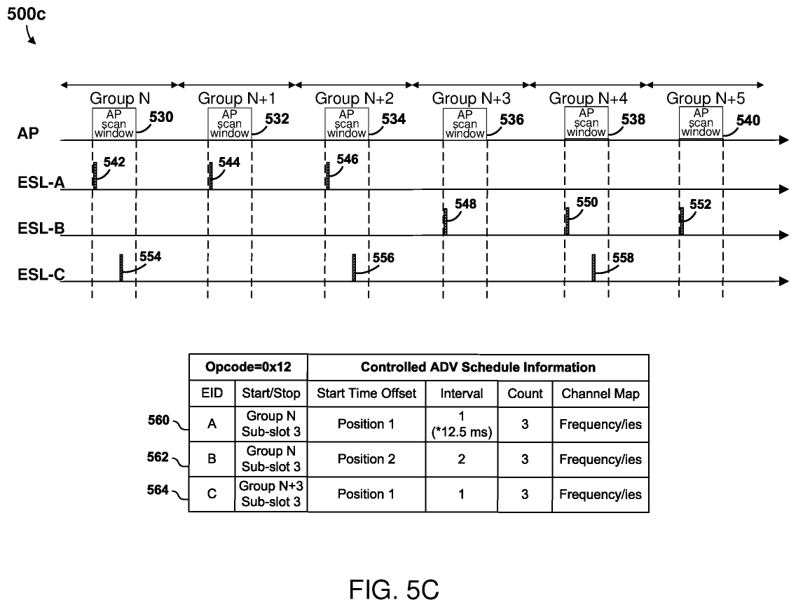

FIG. 5A is a conceptual diagram illustrating a method 500a of scheduling access point and electronic shelf label communication according to various embodiments. FIG. 5B is a block diagram illustrating example scheduling information 500b according to various embodiments. With reference to FIGS. 1-5B, in some embodiments, an AP may transmit to an ESL that is associated with an ESL ID a periodic advertisement 502 that includes scheduling information for an ADV from the ESL. The scheduling information 500b may include an indication of a sub-slot in which no other communication from the AP or the ESL is scheduled (e.g., sub-slot 3). Such other communication may include a periodic advertisement, and ESL response, or other signaling or communications.

The receiving ESL may transmit an ADV 504, 506 to the AP in the indicated sub-slot. The AP may receive the ADV 504, 506 from the ESL in the sub-slot indicated in the periodic advertisement. In some embodiments, the indicated sub-slot may include two or more positions or times in which the ESL may transmit the ADV to the AP. In some embodiments, each position may be 625 microseconds (μs) long. For example, the ADV 504 may be transmitted in a first position, and the ADV 506 may be transmitted in a second position. At least two ADVs from synchronized ESLs of the same group may be scheduled in sequence within sub-slot 3 (e.g., in the first position and the second position).

In some embodiments, the scheduling information may indicate an AP scan window. In some embodiments, the schedule information may indicate a time within the AP scan window. In some embodiments, an ADV scheduled by the AP may be referred to as a “controlled ADV.” The AP also may schedule ADVs in other sub-slots if no other communication activity (or no other higher priority communication activity) is scheduled, or if scheduled communication activity is not performed or is cancelled. For example, the AP may schedule an ADV in sub-slot 5 if the otherwise scheduled communication activity for connection #3 (e.g., an ERP) is not performed or is cancelled. In some embodiments, the AP may configure the scheduling information 500b in a variety of ways, one example of which is illustrated in FIG. 5B. In some embodiments, the scheduling information 500b may include operational code (Opcode) 510, such as Opcode=0x12, for a start/stop Connectable Advertising Packet (CAP). The operational code may include an ESL ID (EID) to which the operational code is addressed, as well as start and stop information.

The scheduling information 500b also may include information indicating information enabling the scheduling of the transmission of an ADV by an ESL to the AP (e.g., Controlled ADV Schedule Information). In some embodiments, the scheduling information 500b may include a start time offset 512 that indicates a time when an ESL should begin transmitting the ADV. In some embodiments, the start time offset 512 may indicate an amount of time after the beginning of a sub-slot, which may correspond with a position within the sub-slot. For example, for the first position in which the ADV 504 is transmitted, the start time offset 512 may be 3.75 milliseconds, and for the second position in which the ADV 506 is transmitted, the start time offset may be 4.375 milliseconds.

The scheduling information 500b also may include interval information 514. The interval information 514 may indicate a rate of repetition at which the ESL should transmit the ADV. For example, an interval of 1 indicates that the ESL should transmit the ADV in consecutive frames or connection intervals; an interval of 2 indicates that the ESL should transmit the ADV in every other consecutive frames or connection intervals; an interval of 3 indicates that the ESL should transmit the ADV in every third consecutive frames or connection intervals; and so forth. The scheduling information 500b also may include a count or counter information 516 that indicates a number of times that the ESL should transmit the ADV. The scheduling information 500b also may include channel map information 518 that indicates one or more advertising channels in which the ESL should transmit the ADV.

FIG. 5C is a conceptual diagram illustrating a method 500c of scheduling access point and electronic shelf label communication according to various embodiments. With reference to FIGS. 1-5C, an AP may send scheduling information 560, 562, 564 to ESL-A, ESL-B, and ESL-C. Each ESL may receive its respective scheduling information and determine when to transmit ADVs to the AP using to its respective scheduling information.

In this example, scheduling information 560 sent by the AP to ESL-A indicates that ESL-A should begin transmitting ADVs in group N, sub-slot 3; in position 1; at an interval of 1 (i.e., in consecutive intervals); the ESL-A should transmit three ADVs; in the frequency or frequencies indicated in the channel map. According to the scheduling information 560, the ESL-A may transmit ADV 542 during AP scan window 530 of group N, ADV 544 during AP scan window 532 of group N+1, and ADV 546 during AP scan window 534 of group N+2.

Scheduling information 562 sent by the AP to ESL-B indicates that ESL-B should begin transmitting ADVs in group N, sub-slot 3; in position 2; at an interval of 2 (i.e., in every other interval); the ESL-B should transmit three ADVs; in the frequency or frequencies indicated in the channel map. According to the scheduling information 562, the ESL-B may transmit ADV 548 during AP scan window 536 of group N+3, ADV 550 during AP scan window 538 of group N+4, and ADV 552 during AP scan window 540 of group N+5.

Scheduling information 560 sent by the AP to ESL-C indicates that ESL-C should begin transmitting ADVs in group N+3, sub-slot 3; in position 1; at an interval of 1 (i.e., in consecutive intervals); the ESL-C should transmit three ADVs; in the frequency or frequencies indicated in the channel map. According to the scheduling information 560, ESL-C may transmit ADV 554 during AP scan window 530 of group N, ADV 556 during AP scan window 534 of group N+2, and ADV 558 during AP scan window 538 of group N+4.

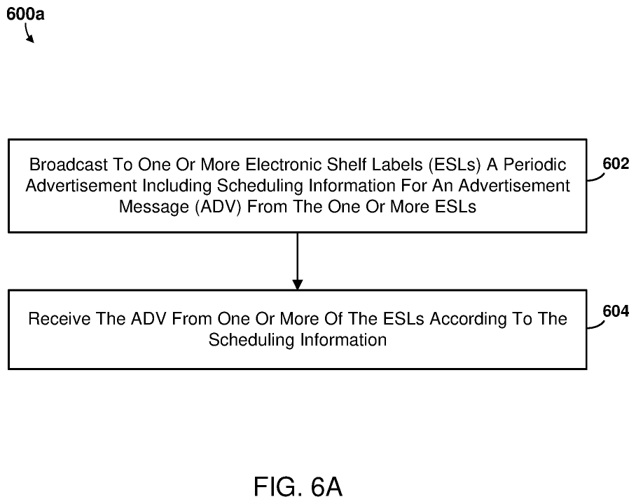

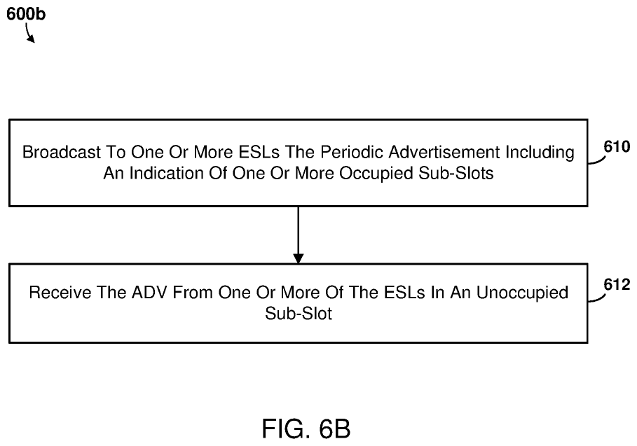

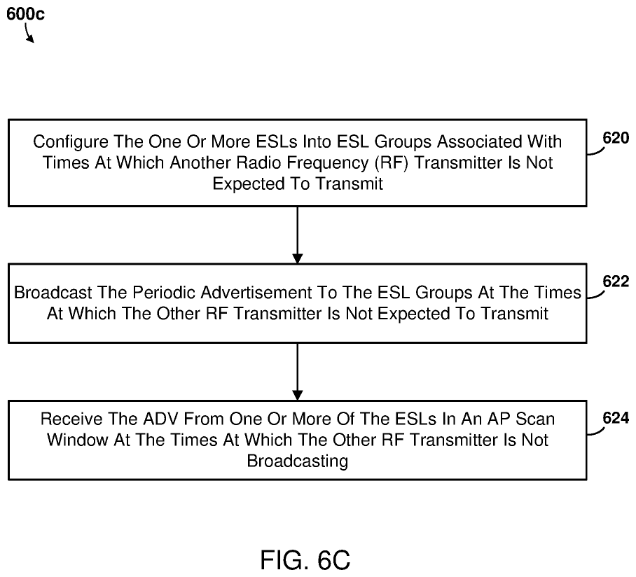

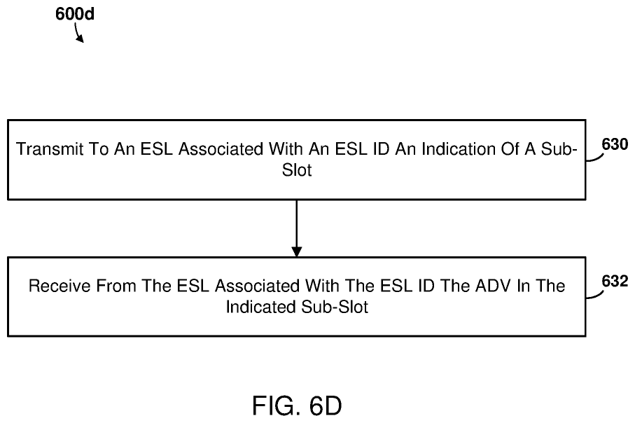

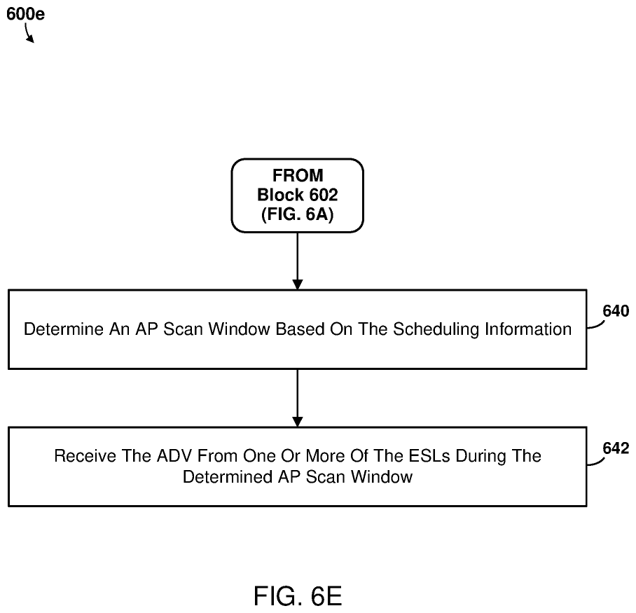

FIG. 6A is a process flow diagram illustrating a method 600a for scheduling access point (AP) and electronic shelf label (ESL) communication according to various embodiments. With reference to FIGS. 1-6A, means for performing the operations of the method 600a may include a processor (e.g., 210, 212, 214, 216, 218, 252, 260, 702, and/or 704) and/or a transceiver (e.g., 266, 268, 817, 818) of an AP (e.g., 130, 200) and the like.

In block 602, the processor may broadcast to one or more electronic shelf labels (ESLs) a periodic advertisement including scheduling information for an advertisement message (ADV) from the one or more ESLs.

In block 604, the processor may receive the ADV from one or more of the ESLs according to the scheduling information.

FIG. 6B is a process flow diagram illustrating operations 600b that may be performed as part of the method 600a for scheduling access point (AP) and electronic shelf label (ESL) communication according to various embodiments. With reference to FIGS. 1-6B, means for performing the operations 600b may include a processor (e.g., 210, 212, 214, 216, 218, 252, 260, 702, and/or 704) and/or a transceiver (e.g., 266, 268, 817, 818) of an AP (e.g., 130, 200) and the like.

In block 610, the processor may broadcast to one or more ESLs the periodic advertisement including an indication of one or more occupied sub-slots. For example, the processor may transmit the periodic advertisement 302 that is configured to include information 310 indicating whether connections or other communications are scheduled in a particular sub-slot. In some embodiments, the processor may broadcast to one or more ESLs the periodic advertisement including a three-bit indication of the occupied sub-slots.

In block 612, the processor may receive the ADV from one or more of the ESLs in an unoccupied sub-slot.

FIG. 6C is a process flow diagram illustrating operations 600c that may be performed as part of the method 600a for scheduling access point (AP) and electronic shelf label (ESL) communication according to various embodiments. With reference to FIGS. 1-6C, means for performing the operations 600c may include a processor (e.g., 210, 212, 214, 216, 218, 252, 260, 702, and/or 704) and/or a transceiver (e.g., 266, 268, 817, 818) of an AP (e.g., 130, 200) and the like.

In block 620, the processor may configure the one or more ESLs into ESL groups associated with times at which another radio frequency (RF) transmitter is not expected to transmit. For example, the processor may configure the one or more ESLs into one or more active groups 402 associated with times at which another RF transmitter (e.g., WLAN 420, 422) is not expected to transmit.

In block 622, the processor may broadcast the periodic advertisement to the ESL groups at times during which the other RF transmitter is not expected to transmit. In some embodiments, the processor may broadcast the periodic advertisement including an indication of the static ratio. For example, the processor may broadcast the periodic advertisement to the ESL groups at the times at which the WLAN 420, 422 is not expected to transmit, which times may be associated with passive groups 404.

In block 624, the processor may receive the ADV from one or more of the ESLs in an AP scan window at the times at which the other RF transmitter is not broadcasting.

FIG. 6D is a process flow diagram illustrating operations 600d that may be performed as part of the method 600a for scheduling access point (AP) and electronic shelf label (ESL) communication according to various embodiments. With reference to FIGS. 1-6D, means for performing the operations 600d may include a processor (e.g., 210, 212, 214, 216, 218, 252, 260, 702, and/or 704) and/or a transceiver (e.g., 266, 268, 817, 818) of an AP (e.g., 130, 200) and the like.

In block 630, the processor may transmit to an ESL associated with an ESL ID an indication of a sub-slot. In some embodiments, the processor may transmit to the ESL associated with the ESL ID an indication of a position in the sub-slot. In some embodiments, the processor may transmit to the ESL associated with the ESL ID an advertising interval, a quantity of ADVs to transmit, and an indication of a channel in which to transmit the ADV. For example, the processor may transmit the scheduling information 500b, that includes the operational code 510 including an ESL ID and start and stop information, the start time offset 512, the interval information 514, account information 516, and the channel map information 518.

In block 632, the processor may receive from the ESL associated with the ESL ID the ADV in the indicated sub-slot. In some embodiments, the processor may receive from the ESL associated with the ESL ID the ADV in the indicated position in the indicated sub-slot. In some embodiments, the processor may receive from the ESL associated with the ESL ID the ADV according to the advertising interval, the quantity of ADVs to transmit, and the indication of the channel in which to transmit the ADV. For example, the processor may receive the ADV 504 and/or the ADV 506 according to the scheduling information 500b.

FIG. 6E is a process flow diagram illustrating operations 600e that may be performed as part of the method 600e for scheduling access point (AP) and electronic shelf label (ESL) communication according to various embodiments. With reference to FIGS. 1-6E, means for performing the operations 600e may include a processor (e.g., 210, 212, 214, 216, 218, 252, 260, 702, and/or 704) and/or a transceiver (e.g., 266, 268, 817, 818) of an AP (e.g., 130, 200) and the like.

After performing the operations of block 602 of the method 600a as described, the processor may determine an AP scan window based on the scheduling information in block 640. For example, the AP may determine an AP scan window based on information such as information about connection(s) with the ESLs (such as BLE connection information) and/or slot or sub-slot occupation information (e.g., whether a slot or sub-slot is being used, or will be used, for other communication operations).

In block 642, the processor may receive the ADV from one or more of the ESLs during the determined AP scan window. In this manner, the AP may determine one or more AP scan windows, and receive ADVs from ESLs during the determined AP scan windows, using information already known by the AP.

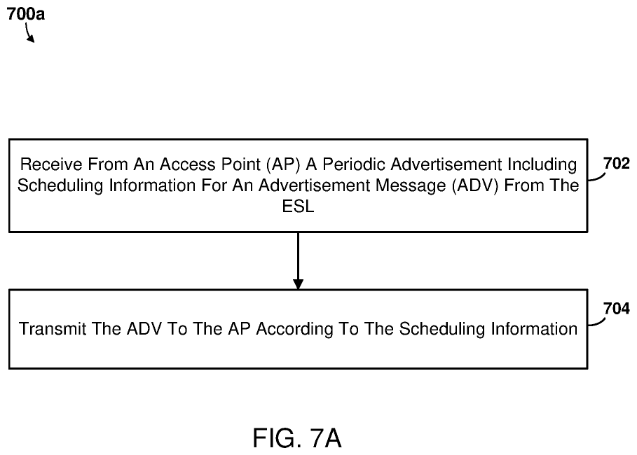

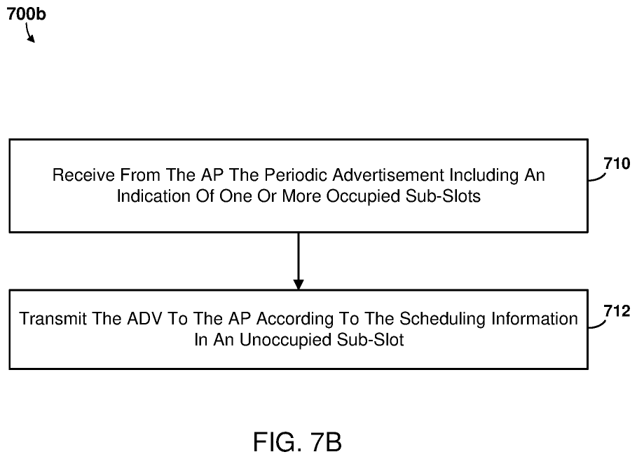

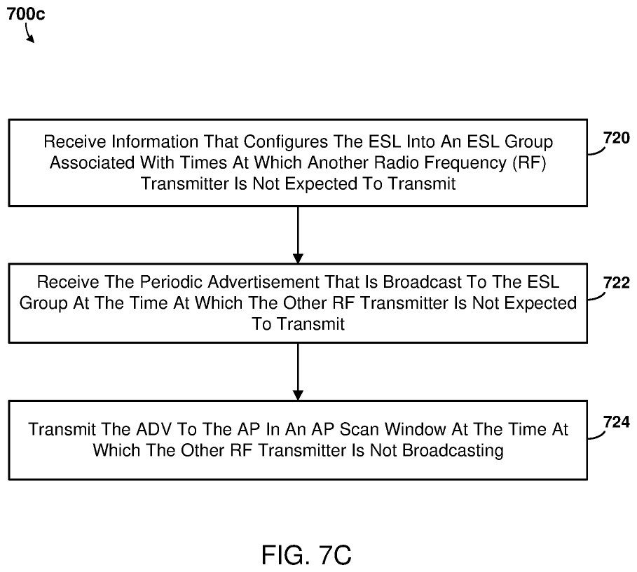

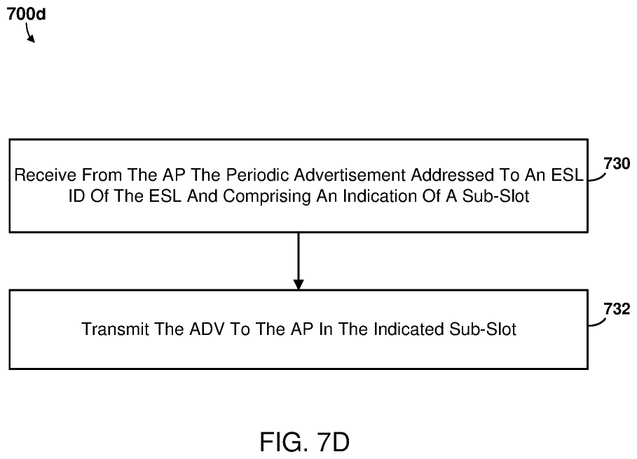

FIG. 7A is a process flow diagram illustrating a method 700a for scheduling access point (AP) and electronic shelf label (ESL) communication according to various embodiments. With reference to FIGS. 1-7A, means for performing the operations of the method 700a may include a processor (e.g., 210, 212, 214, 216, 218, 252, 260, 702, and/or 704) and/or a transceiver (e.g., 704) of an ESL (e.g., 110, 200) and the like.

In block 702, the processor may receive from an access point (AP) a periodic advertisement including scheduling information for an advertisement message (ADV) from the ESL.

In block 704, the processor may transmit the ADV to the AP according to the scheduling information.

FIG. 7B is a process flow diagram illustrating operations 700b that may be performed as part of the method 700a for scheduling access point (AP) and electronic shelf label (ESL) communication according to various embodiments. With reference to FIGS. 1-7B, means for performing the operations 700b may include a processor (e.g., 210, 212, 214, 216, 218, 252, 260, 702, and/or 704) and/or a transceiver (e.g., 704) of an ESL (e.g., 110, 200) and the like.

In block 710, the processor may receive from the AP the periodic advertisement including an indication of one or more occupied sub-slots. For example, the processor may receive the periodic advertisement 302. In some embodiments, the periodic advertisement may include a three-bit indication of the occupied sub-slots.

In block 712, the processor may transmit the ADV to the AP according to the scheduling information in an unoccupied sub-slot.

FIG. 7C is a process flow diagram illustrating operations 700c that may be performed as part of the method 700a for scheduling access point (AP) and electronic shelf label (ESL) communication according to various embodiments. With reference to FIGS. 1-7C, means for performing the operations 700c may include a processor (e.g., 210, 212, 214, 216, 218, 252, 260, 702, and/or 704) and/or a transceiver (e.g., 704) of an ESL (e.g., 110, 200) and the like.

In block 720, the processor may receive information that configures the ESL into an ESL group associated with times at which another radio frequency (RF) transmitter is not expected to transmit. It some embodiments, the processor may receive information that configures the ESL the ESL group according to a static ratio of times at which the other RF transmitter is not expected to transmit and times at which the other RF transmitter is expected to transmit. For example, the processor may receive information that configures the ESL into an active group 402 associated with times at which WLAN 420, 422 is not expected to transmit signals.

In block 722, the processor may receive the periodic advertisement that is broadcast to the ESL group at the time at which the other RF transmitter is not expected to transmit. In some embodiments, the processor may receive the periodic advertisement including an indication of the static ratio. For example, the processor may receive periodic advertisement indicating a ratio of active groups 402 to passive groups 404.

In block 724, the processor may transmit the ADV to the AP in an AP scan window at the time at which the other RF transmitter is not broadcasting. For example, the processor may transmit one or more ADVs (e.g., 410, 412, 414, 416) at a time when WLAN 420, 422 is not expected to transmit signals.

FIG. 7D is a process flow diagram illustrating operations 700d that may be performed as part of the method 700a for scheduling access point (AP) and electronic shelf label (ESL) communication according to various embodiments. With reference to FIGS. 1-7D, means for performing the operations 700d may include a processor (e.g., 210, 212, 214, 216, 218, 252, 260, 702, and/or 704) and/or a transceiver (e.g., 704) of an ESL (e.g., 110, 200) and the like.

In block 730, the processor may receive from the AP the periodic advertisement addressed to an ESL ID of the ESL and comprising an indication of a sub-slot. In some embodiments, the processor may receive receiving from the AP an indication of a position in the sub-slot. In some embodiments, the processor may receive from the AP an advertising interval, a quantity of ADVs to transmit, and an indication of a channel in which to transmit the ADV. For example, the processor may receive the scheduling information 500b.

In block 732, the processor may transmit the ADV to the AP according to the scheduling information comprises transmitting the ADV to the AP in the indicated sub-slot. In some embodiments, the processor may transmit the ADV to the AP in the indicated position in the indicated sub-slot. In some embodiments, the processor may transmit the ADV to the AP according to the advertising interval, the quantity of ADVs to transmit, and the indication of the channel in which to transmit the ADV. For example, the processor may transmit one or more ADVs 542-558 during an AP scan window. In some embodiments, the AP scan window may occur in the indicated sub-slot.

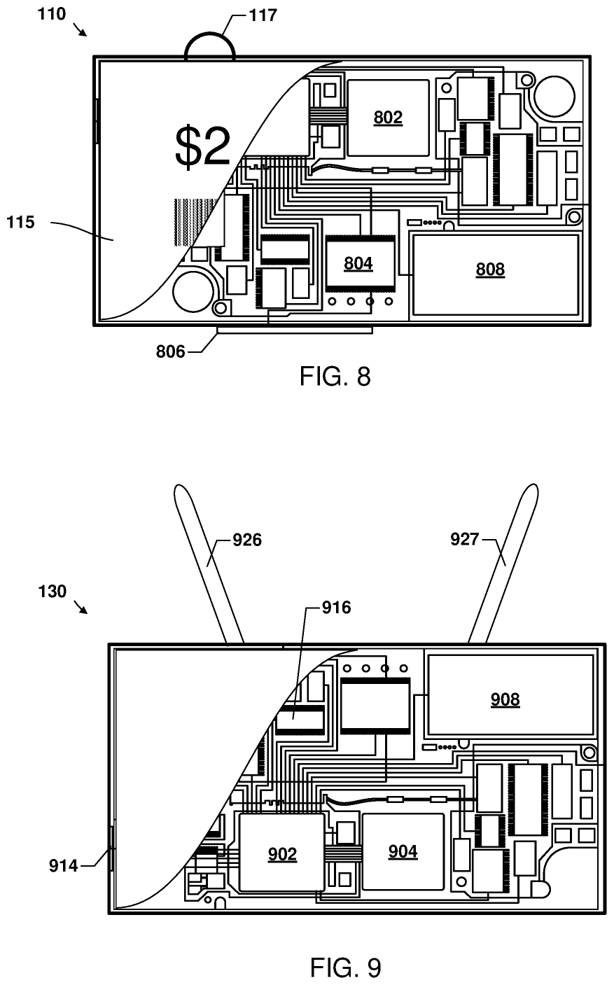

FIG. 8 is a component block diagram of an example of an ESL 110 suitable for use with various embodiments. With reference to FIGS. 1-8, an ESL 110 may include a display 115 and a light emitting diode (LED) 117 (or other type of visible indicator) that our coupled to a processor 802 that is configured with processor-executable instructions configured to cause the processor to perform operations of various embodiments. The processor 802 may be coupled to a wireless transceiver 804, such as a BLE transceiver or a combination BLE and Wi-Fi transceiver, that is coupled to an antenna 806 for sending and receiving RF signals as described herein. In various embodiments, the processor 802 may include an SOC (e.g., 202). An ESL 110 may be powered by a battery 808, freeing the display from having to be connected to a wired power supply. Alternatively, the ESL 110 may be powered from an external source.

FIG. 9 is a component block diagram of an AP 130 suitable for use with various embodiments. With reference to FIGS. 1-9, the AP 130 may typically include a processor 902, 904 coupled to volatile and/or nonvolatile memory 908. The AP 130 may include a first transceiver 916 coupled to an antenna 926, 927 and may be configured to communicate via wireless signals with ESLs, such as a Bluetooth subsystem and radio. The AP 130 may also include a peripheral memory access device, such as a flash drive, coupled to the processor 902, 904. The AP 130 may also include network access ports 914 (or interfaces) coupled to the processor 902, 904 for establishing data connections with a network, such as the Internet and/or a local area network coupled to other system computers and servers. The AP 130 may include additional access ports, such as USB, Firewire, Thunderbolt, and the like for coupling to peripherals, external memory, or other devices.

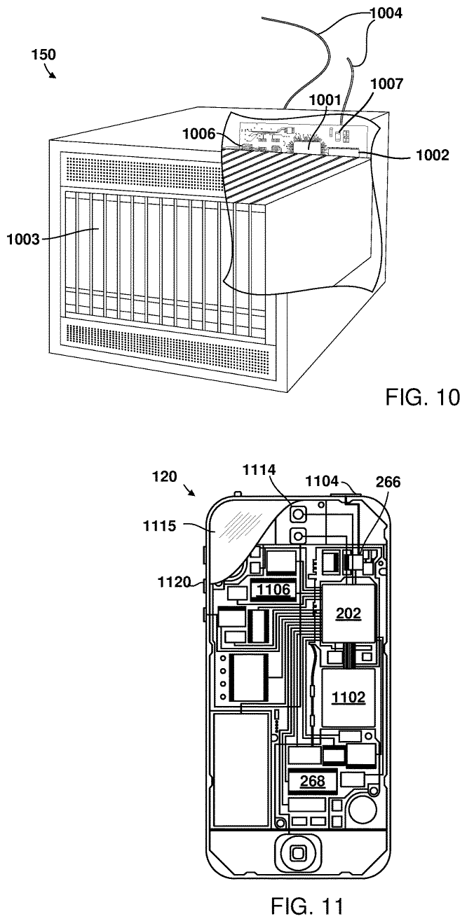

FIG. 10 is a component block diagram of a store management entity server 150 suitable for use with various embodiments. With reference to FIGS. 1-10, the store management entity server 150 may typically include a processor 1001 coupled to volatile memory 1002 and a large capacity nonvolatile memory, such as a disk drive 1003. The store management entity server 150 may also include a peripheral memory access device, such as a floppy disc drive, compact disc (CD) or digital video disc (DVD) drive 1006 coupled to the processor 1001. The store management entity server 150 may also include network access ports 1004 (or interfaces) coupled to the processor 1001 for establishing data connections with a network, such as the Internet and/or a local area network coupled to other system computers and servers. The store management entity server 150 may include one or more antennas 1007 for sending and receiving electromagnetic radiation that may be connected to a wireless communication link. The store management entity server 150 may include additional access ports, such as USB, Firewire, Thunderbolt, and the like for coupling to peripherals, external memory, or other devices.

FIG. 11 is a component block diagram of a user mobile device 120 suitable for use as a user mobile device or a consumer user equipment (UE) when configured with processor executable instructions to perform operations of various embodiments. With reference to FIGS. 1-11, the user mobile device 120 may include a first SOC 202 (e.g., a SOC-CPU) coupled to a second SOC 1102 (e.g., a 5G capable SOC). The first and second SOCs 202, 1102 may be coupled to internal memory 1106, a display 1115, and to a speaker 1114. Additionally, the user mobile device 120 may include an antenna 1104 for sending and receiving electromagnetic radiation that may be connected to a radio module 266 configured to support wireless local area network data links (e.g., BLE, Wi-Fi, etc.) and/or wireless wide area networks (e.g., cellular telephone networks) coupled to one or more processors in the first and/or second SOCs 202, 1102. The user mobile device 120 typically also include menu selection buttons 1120 for receiving user inputs.

A typical user mobile device 120 may also include an inertial measurement unit (IMU) 268 that includes a number of micro-electromechanical sensor (MEMS) elements configured to sense accelerations and rotations associated movements of the device, and provide such movement information to the first SOC 202. Also, one or more of the processors in the first and second SOCs 202, 1102, radio module 266 may include a digital signal processor (DSP) circuit (not shown separately).

In some embodiments, a user mobile device 120 may be used as a moving AP to diagnose ESLs that have issues establishing communication with the APs or other fixed infrastructure. For example, the user mobile device 120 may be repurposed by the store management entity server by configuring the user mobile device 120 with AP protocols so that the user mobile device 120 may be recognized by ESL as an AP.

The processors of ESLs 110, the user mobile device 120, and the store management entity server (e.g., 150) may be any programmable microprocessor, microcomputer or multiple processor chip or chips that can be configured by software instructions (applications) to perform a variety of functions, including the functions of the various embodiments described below. In some user mobile devices, multiple processors may be provided, such as one processor within an SOC 1102 dedicated to wireless communication functions and one processor within an SOC 202 dedicated to running other applications. Typically, software applications may be stored in the memory 1006 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods and operations 300, 400a, 500a, 500c, 600a-600e, and 700a-700d may be substituted for or combined with one or more operations of methods and operations 300, 400a, 500a, 500c, 600a-600e, and 700a-700d.

Implementation examples are described in the following paragraphs. While some of the following implementation examples are described in terms of example methods, further example implementations may include: the example methods discussed in the following paragraphs implemented by an AP or an ESL including a processor configured to perform operations of the example methods; the example methods discussed in the following paragraphs implemented by an or an ESL including means for performing functions of the example methods; the example methods discussed in the following paragraphs implemented in a processor used in an or an ESL that is configured to perform the operations of the example methods; and the example methods discussed in the following paragraphs implemented as a non-transitory processor-readable storage medium having stored thereon processor-executable instructions configured to cause a processor of an or an ESL to perform the operations of the example methods.

Example 1. A method performed by a processor of an access point (AP), including broadcasting to one or more electronic shelf labels (ESLs) a periodic advertisement including scheduling information for an advertisement message (ADV) from the one or more ESLs, and receiving the ADV from one or more of the ESLs according to the scheduling information.

Example 2. The method of claim 1, in which broadcasting to one or more ESLs the periodic advertisement including scheduling information for an ADV from the one or more ESLs includes broadcasting to one or more ESLs the periodic advertisement including an indication of one or more occupied sub-slots, and receiving the ADV from one or more of the ESLs according to the scheduling information includes receiving the ADV from one or more of the ESLs in an unoccupied sub-slot.

Example 3. The method of example 2, in which broadcasting to one or more ESLs the periodic advertisement including the indication of one or more occupied sub-slots includes broadcasting to one or more ESLs the periodic advertisement including a three-bit indication of the occupied sub-slots.

Example 4. The method of any of examples 1-3, in which broadcasting to one or more ESLs the periodic advertisement including scheduling information for an ADV from the one or more ESLs includes configuring the one or more ESLs into ESL groups associated with times at which another radio frequency (RF) transmitter is not expected to transmit, and broadcasting the periodic advertisement to the ESL groups at the times at which the other RF transmitter is not expected to transmit.

Example 5. The method of example 3, in which configuring the one or more ESLs into ESL groups associated with times at which another RF transmitter is not expected to transmit includes configuring the ESL groups according to a static ratio of times at which the other RF transmitter is not expected to transmit and times at which the other RF transmitter is expected to transmit.

Example 6. The method of any of examples 1-5, in which broadcasting to one or more ESLs the periodic advertisement including scheduling information for the ADV from the one or more ESLs includes transmitting to an ESL associated with an ESL ID an indication of a sub-slot, and receiving the ADV from one or more of the ESLs according to the scheduling information includes receiving from the ESL associated with the ESL ID the ADV in the indicated sub-slot.

Example 7. The method of example 6, in which transmitting to the ESL using the associated ESL ID the indication of the sub-slot includes transmitting to the ESL associated with the ESL ID an indication of a position in the sub-slot, and receiving from the ESL associated with the ESL ID the ADV in the indicated sub-slot includes receiving from the ESL associated with the ESL ID the ADV in the indicated position in the indicated sub-slot.

Example 8. The method of example 6, in which transmitting to the ESL associated with the ESL ID the indication of the sub-slot includes transmitting to the ESL associated with the ESL ID an advertising interval, a quantity of ADVs to transmit, and an indication of a channel in which to transmit the ADV, and receiving from the ESL associated with the ESL ID the ADV in the indicated sub-slot includes receiving from the ESL associated with the ESL ID the ADV according to the advertising interval, the quantity of ADVs to transmit, and the indication of the channel in which to transmit the ADV.

Example 9. The method of examples 1-8, in which receiving the ADV from one or more of the ESLs according to the scheduling information includes determining an AP scan window based on the scheduling information, and receiving the ADV from one or more of the ESLs during the determined AP scan window.

Example 10. A method performed by a processor of an electronic shelf label (ESL), including receiving from an access point (AP) a periodic advertisement including scheduling information for an advertisement message (ADV) from the ESL, and transmitting the ADV to the AP according to the scheduling information.

Example 11. The method of example 10, in which receiving from the AP the periodic advertisement including scheduling information for an ADV from the ESL includes receiving from the AP the periodic advertisement including an indication of one or more occupied sub-slots, and transmitting the ADV to the AP according to the scheduling information includes transmitting the ADV to the AP according to the scheduling information in an unoccupied sub-slot.

Example 12. The method of either of examples 10 or 11, in which receiving from the AP the periodic advertisement including scheduling information for an ADV from the ESL includes receiving information that configures the ESL into an ESL group associated with times at which another radio frequency (RF) transmitter is not expected to transmit, and receiving the periodic advertisement that is broadcast to the ESL group at the time at which the other RF transmitter is not expected to transmit.

Example 13. The method of example 12, in which receiving information that configures the ESL into the ESL group associated with times at which another RF transmitter is not expected to transmit includes receiving information that configures the ESL the ESL group according to a static ratio of times at which the other RF transmitter is not expected to transmit and times at which the other RF transmitter is expected to transmit.

Example 14. The method of any of examples 10-13, in which receiving from the AP the periodic advertisement including scheduling information for an ADV from the ESL includes receiving from the AP the periodic advertisement addressed to an ESL ID of the ESL including an indication of a sub-slot, and transmitting the ADV to the AP according to the scheduling information includes transmitting the ADV to the AP in the indicated sub-slot.

Example 15. The method of example 14, in which receiving from the AP the periodic advertisement addressed to the ESL ID of the ESL including the indication of the sub-slot includes receiving from the AP an indication of a position in the sub-slot, and transmitting the ADV to the AP in the indicated sub-slot includes transmitting the ADV to the AP in the indicated position in the indicated sub-slot.

Example 16. The method of example 14, in which receiving from the AP the periodic advertisement addressed to the ESL ID of the ESL including the indication of the sub-slot includes receiving from the AP an advertising interval, a quantity of ADVs to transmit, and an indication of a channel in which to transmit the ADV, and transmitting the ADV to the AP in the indicated sub-slot includes transmitting the ADV to the AP according to the advertising interval, the quantity of ADVs to transmit, and the indication of the channel in which to transmit the ADV.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iDEN), C-V2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are only for illustrative purposes and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1.-15. (canceled)

16. An access point (AP), comprising:
a transceiver; and
a processor coupled to the transceiver and configured to:
broadcast to one or more electronic shelf labels (ESLs) a periodic advertisement including scheduling information for an advertisement message (ADV) from the one or more ESLs; and
receive the ADV from one or more of the ESLs according to the scheduling information.

17. The AP of claim 16, wherein the processor is further configured to:
broadcast to one or more ESLs the periodic advertisement including an indication of one or more occupied sub-slots; and
receive the ADV from one or more of the ESLs in an unoccupied sub-slot.

18. The AP of claim 16, wherein the processor is further configured to:
configure the one or more ESLs into ESL groups associated with times at which another radio frequency (RF) transmitter is not expected to transmit; and
broadcast the periodic advertisement to the ESL groups at the times at which the other RF transmitter is not expected to transmit.

19. The AP of claim 18, wherein the processor is further configured to configure the ESL groups according to a static ratio of times at which the other RF transmitter is not expected to transmit and times at which the other RF transmitter is expected to transmit.

20. The AP of claim 16, wherein the processor is further configured to:
transmit to an ESL associated with an ESL ID an indication of a sub-slot; and
receive from the ESL associated with the ESL ID the ADV in the indicated sub-slot.

21. The AP of claim 20, wherein the processor is further configured to:
transmit to the ESL associated with the ESL ID an indication of a position in the sub-slot; and
receive from the ESL associated with the ESL ID the ADV in the indicated position in the indicated sub-slot.

22. The AP of claim 20, wherein the processor is further configured to:
transmit to the ESL associated with the ESL ID an advertising interval, a quantity of ADVs to transmit, and an indication of a channel in which to transmit the ADV; and
receive from the ESL associated with the ESL ID the ADV according to the advertising interval, the quantity of ADVs to transmit, and the indication of the channel in which to transmit the ADV.

23. The AP of claim 16, wherein the processor is further configured to:
determine an AP scan window based on the scheduling information; and
receive the ADV from one or more of the ESLs during the determined AP scan window.

24. An electronic shelf label (ESL), comprising:
a transceiver; and
a processor coupled to the transceiver and configured to:
receive from an access point (AP) a periodic advertisement including scheduling information for an advertisement message (ADV) from the ESL; and
transmit the ADV to the AP according to the scheduling information.

25. The ESL of claim 24, wherein the processor is further configured to:
receive from the AP the periodic advertisement including an indication of one or more occupied sub-slots; and
transmit the ADV to the AP according to the scheduling information in an unoccupied sub-slot.

26. The ESL of claim 24, wherein the processor is further configured to:
receive information that configures the ESL into an ESL group associated with times at which another radio frequency (RF) transmitter is not expected to transmit; and
receive the periodic advertisement that is broadcast to the ESL group at the time at which the other RF transmitter is not expected to transmit.

27. The ESL of claim 26, wherein the processor is further configured to receive information that configures the ESL the ESL group according to a static ratio of times at which the other RF transmitter is not expected to transmit and times at which the other RF transmitter is expected to transmit.

28. The ESL of claim 24, wherein the processor is further configured to:
receive from the AP the periodic advertisement addressed to an ESL ID of the ESL comprising an indication of a sub-slot; and
transmit the ADV to the AP in the indicated sub-slot.

29. The ESL of claim 28, wherein the processor is further configured to:
receive from the AP an indication of a position in the sub-slot; and
transmit the ADV to the AP in the indicated position in the indicated sub-slot.

30. The ESL of claim 28, wherein the processor is further configured to:
receive from the AP an advertising interval, a quantity of ADVs to transmit, and an indication of a channel in which to transmit the ADV; and
transmit the ADV to the AP according to the advertising interval, the quantity of ADVs to transmit, and the indication of the channel in which to transmit the ADV.
